(19) United States
(12) Patent Application Publication
(10) Pub. No.: US 2007/0291661 A1
(43) Pub. Date: Dec. 20, 2007

(54) Communication apparatus, communication terminal device, communication system, communication method and communication program

(75) Inventors: Yasuyuki Nishibayashi, Kawasaki-shi (JP); Shinya Murai, Kawasaki-shi (JP); Masataka Goto, Yokohama-shi (JP); Kensaku Yamaguchi, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/654,581

(22) Filed: Jan. 18, 2007

(30) Foreign Application Priority Data
Jun. 16, 2006 (JP) 2006-167811

(51) Int. Cl. H04J 1/16; H04L 12/28; H04J 3/22

(52) U.S. Cl. 370/252; 370/254; 370/465

(57) ABSTRACT

A communication apparatus for performing data communication with terminal devices, includes unit acquiring, from the terminal devices, connection information items corresponding to the terminal devices, unit storing the connection information items, unit, when transmitting data to the terminal devices, selecting one of a first scheme and a second scheme referring to the stored connection information items, the first scheme causing the data to be unicasted to the terminal devices, the second scheme causing the data to be unicasted to one terminal device of the terminal devices and then to be multicasted from the one terminal device to the terminal devices other than the one terminal device, and unit transmitting, to the one terminal device, request information requesting the one terminal device to perform processing of data using the second scheme, and also transmitting the data to the one terminal device, when the selection unit selects the second scheme.

### CROSS-REFERENCE TO RELATED APPLICATIONS

This application is based upon and claims the benefit of priority from prior Japanese Patent Application No. 2006-167811, filed Jun. 16, 2006, the entire contents of which are incorporated herein by reference.

### BACKGROUND OF THE INVENTION

1. Field of the Invention

The present invention relates to a communication apparatus, communication terminal device, communication system, communication method and communication program for use in a system that contains, in the communication path, a network incompatible with multicasting.

2. Description of the Related Art

There is a computing system for enhancing the usability, in which a communication terminal device having an input/output interface of a minimal capacity is provided at the user side, and a communication apparatus as a main unit remote from the terminal device performs complex computations. For this system, a system configuration has been proposed in which the screen information of the communication apparatus (such as a personal computer) is transferred to the terminal device (such as a display device) via a network (see, for example, U.S. Pat. No. 6,784,855). In this configuration, the information input via the display device (through, for example, a digitizer) is transferred to the communication apparatus via the network, and the communication apparatus executes actual processing of an application program. After that, the execution result and screen update information are transferred to the terminal device via the network, and the terminal device, in turn, executes output processing.

When there exist a large number of terminal devices, to which the communication apparatus as the main unit should transmit video information, it is desirable to perform multicasting. This is because unicasting may waste, in particular, wireless network bandwidth (may cause packet loss due to signal collision). Unicasting is a one-to-one communication scheme, which may cause, for example, an increase in the load on the transmission device, or waste of the network bandwidth. On the other hand, multicasting can reduce extra traffic by simultaneous distribution of the same information to a plurality of terminal devices requesting it.

In multicasting through a Transmission Control Protocol/Internet Protocol (TCP/IP) network, routers in the communication path automatically copy information and send the copies to destinations, and hence efficient distribution can be performed without waste of the bandwidth. This being so, multicasting on the TCP/IP network is utilized when, for example, distributing video data through the Internet.

However, when routers that are incompatible with multicasting exist in the communication path, multicasting cannot be executed. Further, when a large number of multicast routers to be passed exist, multicasting cannot be succeeded because of packet disposal due to a limit of the hop count of multicast packets. As mentioned above, when a network incompatible with multicasting exists in the communication path, or when a large number of multicast routers to be passed exist, video information cannot efficiently be delivered from the communication apparatus by multicasting.

### BRIEF SUMMARY OF THE INVENTION

In accordance with an aspect of the invention, there is provided a communication apparatus for performing data communication with a plurality of terminal devices, comprising: an acquisition unit configured to acquire, from the terminal devices, a plurality of connection information items corresponding to the terminal devices; a storage unit configured to store the connection information items; a selection unit configured to, when transmitting data to the terminal devices, select one of a first scheme and a second scheme referring to the stored connection information items, the first scheme causing the data to be unicasted to the terminal devices, the second scheme causing the data to be unicasted to one terminal device of the terminal devices and then to be multicasted from the one terminal device to the terminal devices other than the one terminal device; and a transmission unit configured to transmit, to the one terminal device, request information requesting the one terminal device to perform processing of data using the second scheme, and also to transmit the data to the one terminal device, when the selection unit selects the second scheme.

In accordance with another aspect of the invention, there is provided a terminal device included in a plurality of terminal devices which perform data communication with a communication apparatus, the terminal device comprising: an acquisition unit configured to acquire instruction information and data from the communication apparatus, the instruction information indicating one of a first scheme and a second scheme, the first scheme causing data to be unicasted to the terminal devices, the second scheme causing data to be unicasted to one terminal device of the terminal devices and then to be multicasted from the one terminal device to the terminal devices other than the one terminal device; a selection unit configured to select, referring to the instruction information, whether the data is to be multicasted to the terminal devices other than the one terminal device; and a transmission unit configured to transmit by multicasting the data to the terminal devices other than the one terminal device, when the selection unit selects that the data is to be multicasted to the terminal devices other than the one terminal device.

### BRIEF DESCRIPTION OF THE SEVERAL VIEWS OF THE DRAWING

FIG. 1 is a block diagram illustrating a communication apparatus according to an embodiment;

FIG. 2 is a block diagram illustrating a communication terminal device according to the embodiment;

FIG. 3 is a view illustrating a conventional communication system as a first comparative example;

FIG. 4 is a view illustrating a communication system as a first comparative example of the embodiment;

FIG. 5A is a view illustrating a conventional communication system as a second comparative example, in which two communication terminal devices are employed;

FIG. 5B is a view illustrating a communication system as a second comparative example of the embodiment, in which two communication terminal devices are employed;

FIG. 6A is a view illustrating a conventional communication system as the second comparative example, in which three communication terminal devices are employed;

FIG. 6B is a view illustrating a communication system as the second comparative example of the embodiment, in which three communication terminal devices are employed;

FIG. 7 is a view illustrating a conventional communication system as a third comparative example;

FIG. 8 is a view illustrating a communication system as a third comparative example of the embodiment;

FIG. 9 is a view illustrating a communication system according to the embodiment, which controls communication terminal devices with reference to the transfer capability of the terminal devices;

FIG. 10 is a view illustrating a sequence of processes for reporting the remaining battery power of a communication terminal device, employed in the embodiment;

FIG. 11 is a view useful in explaining an IEEE 802.11 protocol operation performed in the embodiment;

FIG. 12 is a view illustrating address field values in FIG. 11;

FIG. 13A is a view illustrating a multicast-transport start request packet transmitted in the communication system of the embodiment;

FIG. 13B is a view illustrating a multicast-transport stop request packet transmitted in the communication system of the embodiment;

FIG. 14 is a view illustrating an unstable-state report packet transmitted in the communication system of the embodiment;

FIG. 15A is a view illustrating a connection information inquiry packet transmitted in the communication system of the embodiment;

FIG. 15B is a view illustrating a connection information report packet transmitted in the communication system of the embodiment;

FIG. 16 is a view illustrating a sequence of use of the packets shown in FIGS. 13A to 15B;

FIG. 17 is a flowchart illustrating an operation example of the communication apparatus of the embodiment;

FIG. 18A is a flowchart illustrating a first operation example of the communication terminal device of the embodiment;

FIG. 18B is a flowchart illustrating a first operation example of the communication apparatus of the embodiment;

FIG. 19A is a flowchart illustrating a second operation example of the communication terminal device of the embodiment;

FIG. 19B is a flowchart illustrating a second operation example of the communication apparatus of the embodiment;

FIG. 20A is a block diagram illustrating a modification of the communication terminal device of the embodiment; and

FIG. 20B is a block diagram illustrating an access point device employed in the embodiment.

### DETAILED DESCRIPTION OF THE INVENTION

A communication apparatus, communication terminal device, communication system, communication method and communication program according to an embodiment will be described in detail with reference to the accompanying drawings.

In the communication apparatus, communication terminal device, communication system, communication method and communication program according to the embodiment, data can efficiently be transmitted through multicasting, even if a network incompatible with multicasting exists in the communication path.

In the communication system according to the embodiment, efficient information distribution is realized by executing control for detecting the number of destination communication terminal devices (hereinafter referred to as “the terminal devices”), to which the communication apparatus as a main unit should transmit information, and executing control for interrupting unicasting by the communication apparatus to perform multicast transfer via a single terminal device, when the number of the terminal devices exceeds a preset threshold value.

In the embodiment, the communication apparatus as the main unit transmits information to each terminal device, utilizing unicasting. When the number of the terminal devices existing in the same BSS (Basic Service Set is a set of stations controlled by a single coordination function.) reaches four, the communication apparatus selects an arbitrary terminal device from the four devices, transmits information to the selected terminal device utilizing unicasting, and stops unicasting of information to the other terminal devices. The selected terminal device, which has received information unicasted from the communication apparatus, in turn, multicasts the information to the other terminal devices in the same wireless network. In the IEEE 802.11 infrastructure mode, a multicast packet transmitted by a terminal device as a station (STA) always passes an access point (AP). When the number of the terminal devices is four or more, more efficient information distribution can be achieved by multicasting information from one terminal device to the other terminal devices, than by directly distributing information to the other terminal devices utilizing unicasting.

Further, where unicasting is realized using an acknowledgement type transport protocol, such as a transmission control protocol (TCP), if three or more terminal devices are employed, efficient transmission is realized by causing a terminal device to return multicast data. This is because medium access control (MAC) frames are bi-directionally transmitted between the AP and STA in a wireless local area network (LAN) zone.

Furthermore, the reliability of the entire system is enhanced by excluding, from multicast transport targets, a terminal device having no extra power for multicast transport and a terminal device in an unstable channel state, because of a remaining low battery power.

The communication system of the embodiment is in a system environment, in which, for example, the screen information of the communication apparatus as the main unit located at your own office is used in common by a plurality of display devices (corresponding to the terminal devices employed in the embodiment) located in, for example, a conference room remote therefrom. The display devices are associated with the access point device which enables the display devices to receive the screen information of the remote communication apparatus. Assume here that the communication apparatus transmits the same screen information to the display devices.

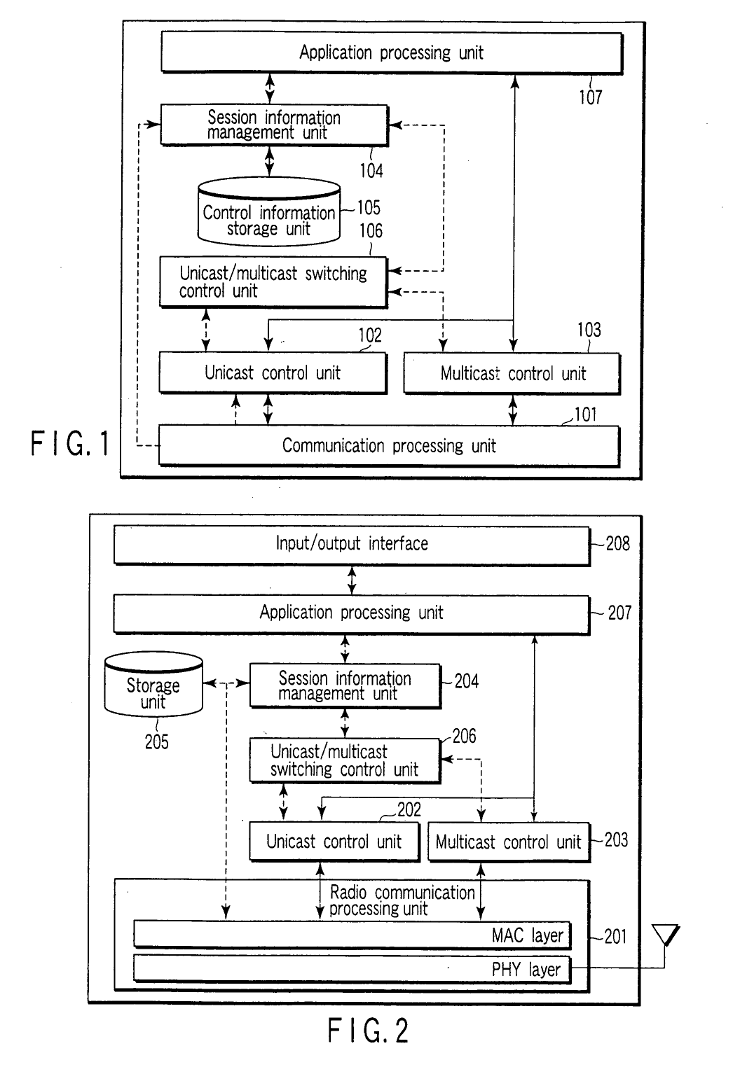

Referring now to FIG. 1, the communication apparatus of the embodiment will be described. In FIG. 1, the broken lines indicate the flow of control information, and the solid lines indicate the data other than the control data.

As shown in FIG. 1, the communication apparatus of the embodiment comprises a communication processing unit 101, unicast control unit 102, multicast control unit 103, session information management unit 104, control information storage unit 105, unicast/multicast switching control unit 106 and application processing unit 107. In the following description, elements similar to those described above are denoted by corresponding reference numbers, and no description is given thereof.

The communication processing unit 101 performs control for transmitting information packets via a wired or wireless physical medium. More specifically, the communication processing unit 101 performs wired-communication processing of, for example, the IEEE 802.3 standards, in which access control is performed using Carrier Sense Multiple Access with Collision Detection (CSMA/CD). Further, when the communication apparatus on a remote network (including a plurality of routers located in the communication path) is connected to the access point device wirelessly, the unit 101 performs wireless-communication processing of the IEEE 802.11 standards. In the following embodiment, assume that the communication apparatus as the main unit is connected to a network by wired connection.

The unicast control unit 102 transmits information, supplied from an application program, to a terminal device via the network, utilizing unicasting.

When causing a certain terminal device to perform multicast transport or causing it to stop the multicast transport, the multicast control unit 103 performs control for unicasting information indicating the start or stop of multicast transport to the terminal device via the network. Internet protocol (IP) multicast group addresses is conversed into Medium Access Control (MAC) addresses, whereby each terminal device selects and receives only multicast data corresponding to itself. In the embodiment, the multicast control unit 103 may use preset multicast addresses. Alternatively, the unit 103 may perform dynamic control such as preparation and distribution of addresses. In the following description, assume that all the communication apparatuses and terminal devices use preset fixed multicast addresses.

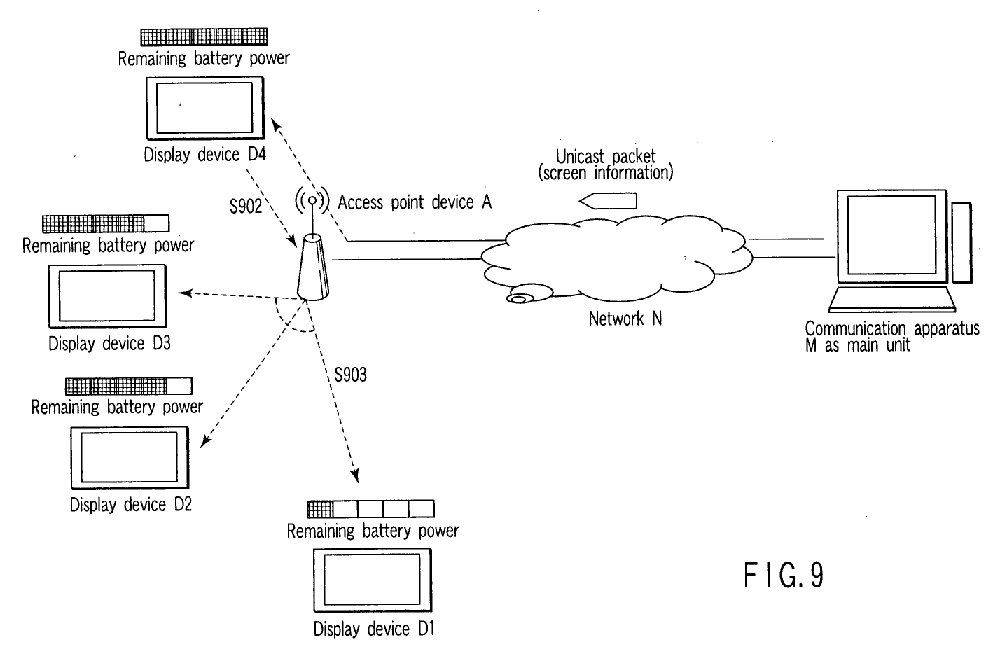

When a terminal device starts to use an application in the communication apparatus (session start), the session information management unit 104 manages the transport protocol, the user identifier, the information concerning the access point device currently associated, and session information (also called “connection information”) such as the remaining battery power of the terminal device. The session information management unit 104 acquires connection information concerning the terminal devices via the communication processing unit 101 and network, thereby detecting the number of terminal devices as destinations of information transmission, information (e.g., remaining battery power) unique to each terminal device, and the wireless channel environment of each terminal device, and storing the detected information in the control information storage unit 105. The wireless channel environment is determined from, for example, the received signal strength of each terminal device and the Received Signal Strength Indicator (RSSI). Specifically, if the received signal strength is lower than the threshold value preset by the RSSI, the wireless channel environment is determined to be bad. The case of using remaining battery power as connection information will be described later with reference to FIG. 9.

The session information management unit 104 refers to the information stored in the control information storage unit 105, thereby determining whether data be unicasted to each terminal device, or be multicasted thereto via a certain terminal device. If, for example, it is determined that the number of terminal devices as information destinations exceeds the preset threshold value, it is determined that unicasting of data to each terminal device should be switched to multicasting of data to each terminal device via a certain terminal device. The determination result is transferred to the unicast/multicast switching control unit 106. When performing multicast transport, the session information management unit 104 also determines which terminal device should perform multicast transport, referring to the connection information concerning the terminal devices, and transmits, to each terminal device via the communication processing unit 101, selection-designating information designating whether each terminal device should perform unicasting or multicasting.

The control information storage unit 105 stores the connection information concerning the terminal devices received by the session information management unit 104 via the session information management unit 104 and communication processing unit 101. The connection information concerning the terminal devices includes, for example, the number of terminal devices as information transmission destinations, information (e.g., remaining battery power) unique to each terminal device, and the wireless channel environment of each terminal device. Note that it may be determined which terminal device should receive the connection information from the control information storage unit 105, and which terminal device(s) should receive data multicast from the determined terminal device.

The unicast/multicast switching control unit 106 receives the selection-designating information from the communication processing unit 101, and switches communication processing between unicasting of data to each terminal device and multicasting of data to terminal devices via a certain terminal device.

The application processing unit 107 generates video or audio information to be output from each terminal device, based on the execution results of the application program, and transmits the information to the network via the unicast control unit or multicast control unit.

Referring to FIG. 2, the terminal device according to the embodiment will be described. Also in FIG. 2, the broken lines indicate the flow of control data, and the solid lines indicate the data other than the control data.

As shown in FIG. 2, the terminal device of the embodiment comprises a radio communication processing unit 201, unicast control unit 202, multicast control unit 203, session information management unit 204, storage unit 205, unicast/multicast switching control unit 206, application processing unit 207 and input/output interface 208.

The radio communication processing unit 201 performs communication processing that complies with the IEEE 802.11 standards. Specifically, the radio communication processing unit 201 performs processing concerning the MAC layer and physical (PHY) layer under the IEEE 802.11 standards. The IEEE 802.11 standards also stipulate supports for multicasting, and wireless MAC frames with multicast addresses designated are received by all terminal devices that belong to the multicast group. In IEEE 802.11 wherein Carrier Sense Multiple Access with Collision Avoidance (CSMA/CA) is employed as medium access control, an increase in communication speed is realized by a change in physical protocol. Concerning the 2.4 GHz frequency bandwidth, IEEE 802.11b (11 Mbps) and IEEE 802.11g (54 Mbps) have been created from IEEE 801.11 (2 Mbps). Concerning 5 GHz frequency bandwidth, IEEE 802.11a exists at present. Further, to develop standards for aiming at different ways of speed-up in the 2.4 GHz frequency bandwidth and 5 GHz frequency bandwidth, IEEE 802.11 TGn (TGn: Task Group n) have been established, and standardizing activities are now being performed.

The unicast control unit 202 receives information unicasted from the communication apparatus, and sends the information to the application processing unit 207. Further, the unit 202 sends information, input to the terminal device, to the communication apparatus via the radio communication processing unit 201. The operation of the unit 202 is determined by an instruction from the unicast/multicast switching control unit 206.

When the terminal device functions as a multicast transfer terminal, the multicast control unit 203 receives information unicasted from the communication apparatus, and sends the information to the application processing unit 207. Further, the unit 203 multicasts the information to the other terminal devices belonging to the same BSS of wireless network. The operation of the unit 203 is determined by an instruction from the unicast/multicast switching control unit 206.

In accordance with the selection-designating information received from the communication apparatus via the radio communication processing unit 201, the session information management unit 204 determines whether data transport should be performed under the control of the unicast control unit 202 or multicast control unit 203, and transfers the determination result as instruction information to the unicast/multicast switching control unit 206. Alternatively, the unit 204 may receive connection information for each terminal device from the communication apparatus via the radio communication processing unit 201, and determine, referring to the connection information, whether data transfer should be performed under the control of the unicast control unit 202 or multicast control unit 203.

The storage unit 205 stores the detected remaining battery power of the terminal device, and also stores the wireless channel environment information acquired from the wireless MAC layer of the radio communication processing unit 201, and the information of the connected access point device. The wireless channel environment may be determined by the above-mentioned RSSI or based on whether an acknowledgement of transmission at the MAC layer is returned. In this case, for example, the session information management unit 204 counts the number of times of retransmission, and if the number reaches a threshold value, it is determined that the wireless channel environment is bad.

Upon receiving the instruction information from the session information management unit 204, the unicast/multicast switching control unit 206 switches the way of communication processing between unicasting and multicasting. For instance, when the terminal device receives an instruction to start an operation as a multicast transport terminal, an instruction to switch the communication process performed under the control of the unicast control unit 202 to that performed under the control of the multicast control unit 203 is transferred to the unicast control unit 202 and multicast control unit 203.

The application processing unit 207 transfers, to the input/output interface 208, video or audio information transmitted from the communication apparatus, and transmits information, input to the terminal device, to the communication apparatus via the network.

The input/output interface 208 outputs, through a display (not shown) or speaker (not shown), the video or audio information received from the communication apparatus via the network. Further, the interface 208 transfers, to the application processing unit 207, information input through the digitizer or keyboard.

The terminal device may have the same structure as that of the communication apparatus shown in FIG. 1. Even in this case, the following embodiment is established.

### FIRST COMPARATIVE EXAMPLES

### Switching Control Performed Under the Initiative of the Communication Apparatus

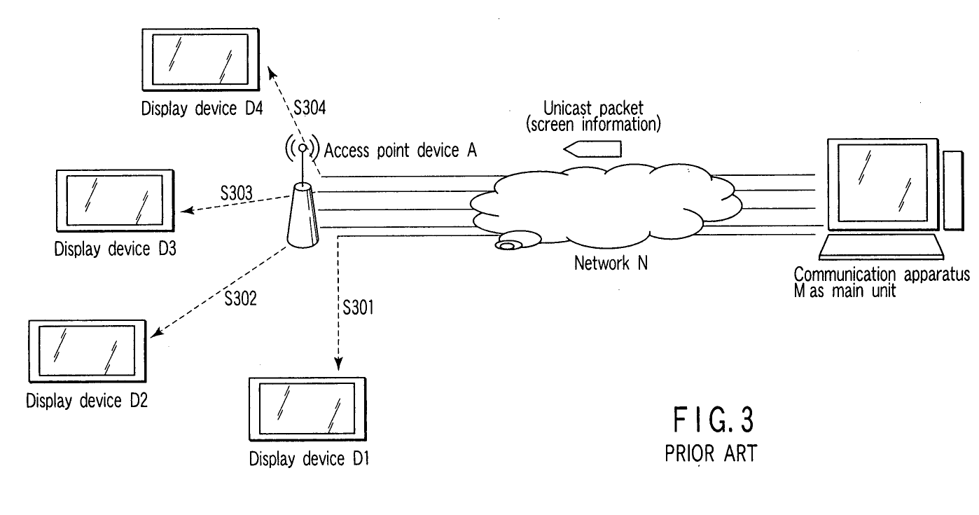

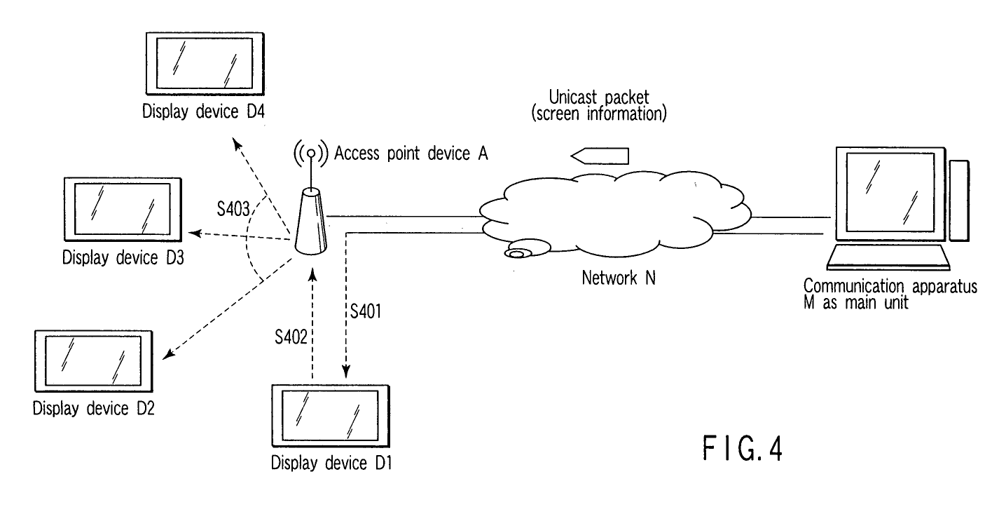

Referring to FIGS. 3 and 4, a description will be given of a first communication system example of the embodiment and a first conventional communication system example. FIG. 3 shows the first conventional communication system example (see, for example, U.S. Pat. No. 6,784,855), and FIG. 4 shows the first communication system example of the embodiment. In the following description, the same step as the above-mentioned one is denoted by the same reference number, and no description is given thereof.

In the conventional communication system shown in FIG. 3, a communication apparatus M as a main unit transmits same screen information to terminal devices (display devices D1 to D4) through unicasting based on User Datagram Protocol/Internet Protocol (UDP/IP). Upon receiving the image information, each display device performs display processing. In FIG. 3, four display devices are associated with a common access point device A (the procedure of association/disassociation is based on the IEEE 802.11 standards). Accordingly, in the example of FIG. 3, concerning the four display devices, the access point device A transmits a wireless MAC frame four times in total (S301, S302, S303 and S304).

In contrast, in the communication system of the embodiment shown in FIG. 4, screen information sent from a communication apparatus M by UDP/IP unicasting is received and displayed by a display device D1 via a network N (step S401). Subsequently, the display device D1 transmits the screen information (MAC frame) to the other terminal devices (the other display devices), with the destination address of the MAC frame set to a multicast address. In the IEEE 802.11 standards, a multicast packet transmitted by a wireless terminal device is firstly unicast to a wireless access point device and then multicast therefrom. In the example of FIG. 4, the screen information of the communication apparatus M is unicast from the display device D1 to the access point device A (step S402), and then multicast from the access point device A to the display devices D2 to D4 (step S403).

In the basic embodiment of the invention shown in FIG. 4, wireless MAC-frame transmission is performed three times in total. Namely, unicasting from the access point device to a display device, unicasting from the display device to the access point device, and multicasting from the access point device A to a plurality of display devices are performed. Compared to the conventional communication system of FIG. 3, the communication system of FIG. 4 can realize efficient information distribution from the communication apparatus. Since the difference in information distribution efficiency between the systems of FIGS. 3 and 4 becomes conspicuous as the number of display devices incorporated in the system increases, the effect of the communication system of the embodiment is evident. Specifically, in the conventional communication system, the number y of times of MAC-frame transmission to x display devices is y=x, i.e., the number y increases linearly. In contrast, in the communication system of the embodiment, y is a fixed number of 3. Further, in the communication system of the embodiment, even if a router incompatible with multicasting exists in the network N between the communication apparatus M and the display devices D1 to D4, data distribution can be executed without problems.

### SECOND COMPARATIVE EXAMPLES

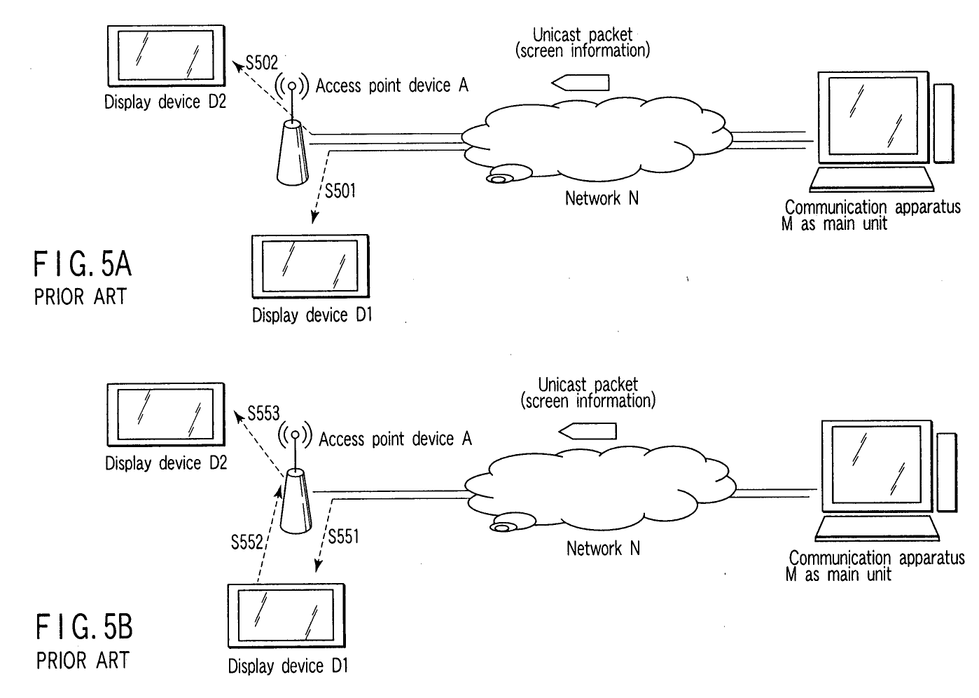

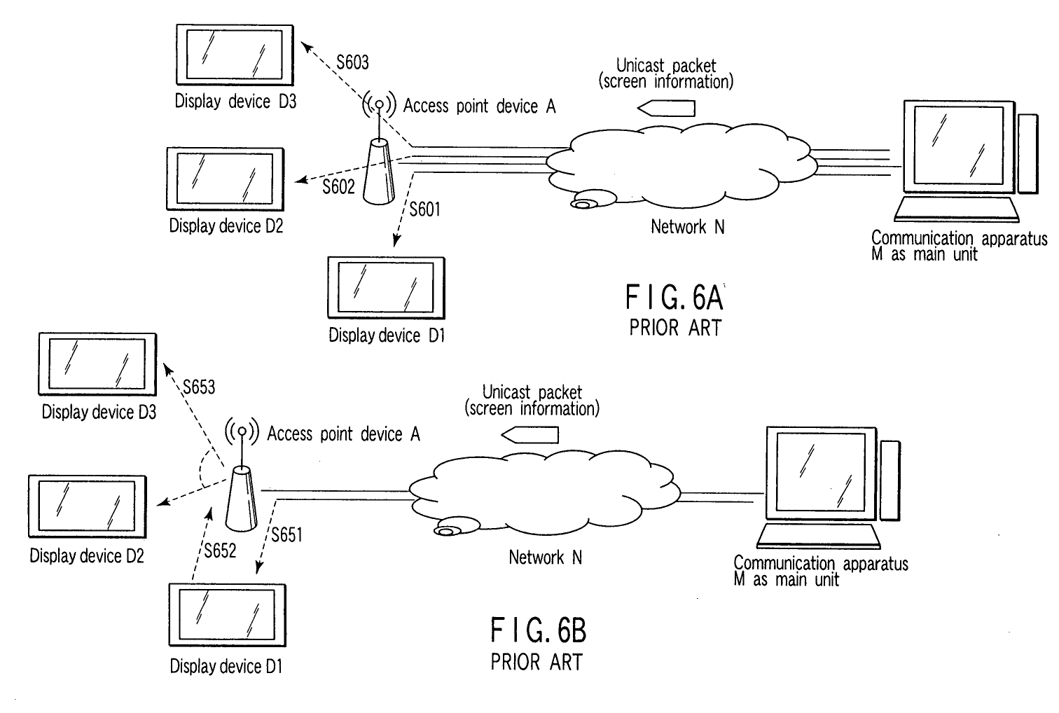

Referring then to FIGS. 5A, 5B, 6A and 6B, a description will be given of second communication system examples of the embodiment and second conventional communication system examples. In these examples, unicasting system and multicast transfer system are compared between the cases where different numbers of terminal devices are employed. In the conventional communication system, information is unicasted to all terminal devices. In the communication system of the embodiment, information is unicasted to a certain terminal device, and is then multicasted to the other terminal devices via the certain terminal device.

FIGS. 5A and 6A show the second conventional communication system examples, while FIGS. 5B and 6B show the second communication system examples of the embodiment. Further, FIGS. 5A and 5B show the cases where two display device are associated with a single access point device, while FIGS. 5A and 5B show the cases where three display device are associated with a single access point device.

In the case of FIG. 5A, the access point device A transmits a wireless MAC frame to each of two display devices (D1, D2), i.e., performs transmission twice in total. On the other hand, if screen information unicasted from the communication apparatus M is received by the display device D1, and then multicasted to the display device D2 via the access point device A, as is shown in FIG. 5B, MAC-frame transmission must be performed three times in total. Thus, the conventional system utilizing only unicasting is more efficient than the system of the embodiment.

In the case of FIG. 6A, the access point device A transmits a wireless MAC frame to each of three display devices (D1 to D3), i.e., performs transmission three times in total. On the other hand, in the case of FIG. 6B, wireless MAC frame transmission is performed three times in total. Namely, unicasting of a MAC frame from the access point device A to the display device D1, unicasting of the MAC frame from the display device D1 to the access point device A, and multicasting of the MAC frame from the access point device A to the display devices D2 and D3 are performed. Thus, in the case where three display devices are employed, the conventional system and the system of the embodiment exhibit the same efficiency.

From the above, it is understandable that when four or more display devices (terminal devices) exist in the same BSS, it is desirable to transfer, via a single display device to the other display devices, information from the communication apparatus, utilizing multicasting.

### THIRD COMPARATIVE EXAMPLES

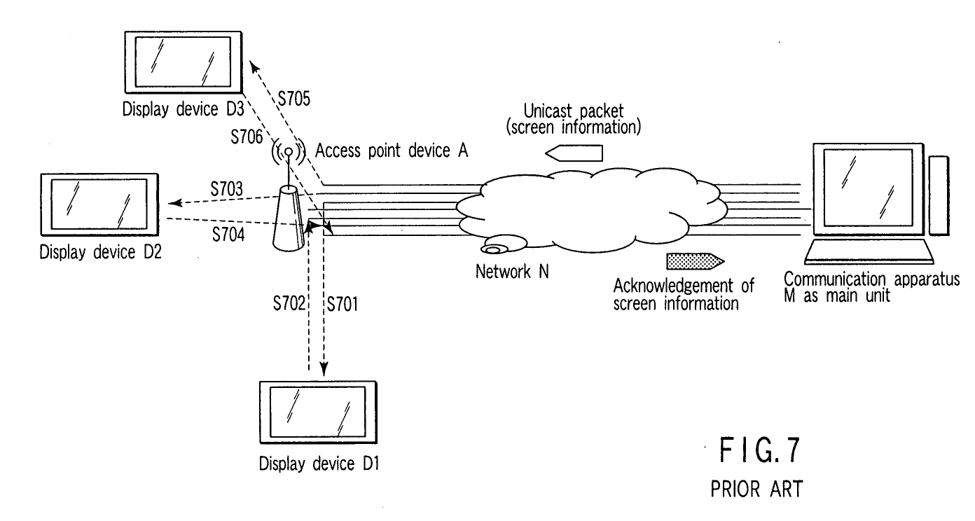

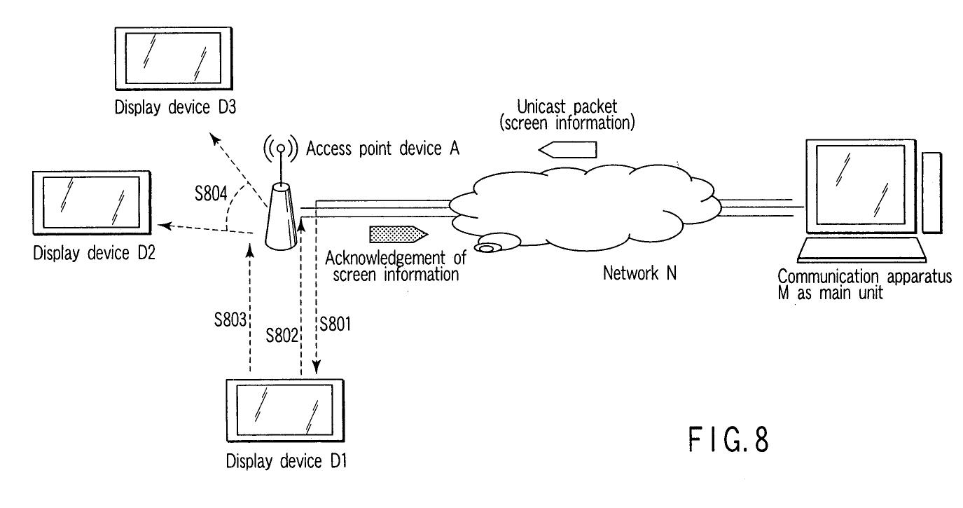

Referring to FIGS. 7 and 8, a description will be given of a third communication system example of the embodiment and third conventional communication system example. FIG. 7 shows the third conventional communication system example, and FIG. 8 shows the third communication system example of the embodiment. In the system examples of FIGS. 7 and 8, such a bidirectional communication protocol as the above-mentioned TCP utilizing an acknowledgement. In both cases, the same screen information is transmitted to a plurality of display devices (D1 to D3) utilizing TCP/IP, and transport-layer-level retransmission control is performed based on a TCP acknowledgement (ACK) from each display device.

In the conventional system example of FIG. 7, the information sent from the communication apparatus M is unicasted from the access point device A to the three display devices (D1 to D3) via the network N. However, different from UDP/IP, a TCP acknowledgement frame is returned from each display device to the communication apparatus M. Even the TCP acknowledgement frame is treated as a data frame in the MAC layer of the IEEE 802.11 standards. Accordingly, in the example of FIG. 7, wireless MAC frame transmission is performed twice between the access point device A and the display device D1 (steps S701 and S702). Similar control is performed on the display devices D2 and D3, therefore MAC frame transmission is performed six times in total in the entire BSS.

In the system example of the embodiment shown in FIG. 8, screen information from the communication apparatus M is transmitted to the display device D1 via the access point device A (step S801). The display device D1 unicasts, to the communication apparatus M, a TCP acknowledgement corresponding to the received screen information (step S802). After that, the screen information is multicasted to the other display devices via the display device D1 and access point device A. Since multicasting is based on UDP/IP, acknowledgements from the display devices D2 and D3 are not needed. Accordingly, unicasting from the display device D1 to the access point device A (step S803), and multicasting from the access point device A to the display devices D2 and D3 (step S804) are performed, with the result that wireless MAC frame transmission is performed four times in total.

From the above, it is understandable that it is desirable to switch unicasting from the communication apparatus to each terminal device, to multicasting via a single terminal device, when the communication apparatus distributes information utilizing TCP/IP, and the number of terminal devices in the same BSS is three or more. If the number of terminal devices in the same BSS is two, the unicasting system achieves more efficient transmission as described above.

(Transfer Capability of Terminal Device)

Referring to FIG. 9, a description will be given of the operation of the communication apparatus for controlling a terminal device with reference to the transfer capability of the terminal device.

In FIG. 9, the communication apparatus M distributes screen information to display devices D1 to D4. Assume here that each display device in FIG. 9 is powered by, for example, a battery, and no power supply adaptor is used. In FIG. 9, the remaining battery power levels of the display devices D1, D2, D3 and D4 are 1/5, 4/5, 4/5 and 5/5 of the completely charged state, respectively. The session information management unit 104 of the communication apparatus acquires the remaining battery power levels from the terminal devices, and stores them in the control information storage unit 105 in relation to the terminal devices.

In the case of FIG. 9, since, for example, the remaining battery power of the display device D1 is low, the session information management unit 104 determines that it is difficult for the display device D1 to multicast information to the display devices D2 to D4. Subsequently, the session information management unit 104 transmits, to the display device D1, an instruction to cause the display device D1 to receive information multicast via one of the display devices D2 to D4, instead of transmitting, to the display device D1, an instruction to perform multicasting. For instance, the session information management unit 104 determines that it is desirable that a terminal device, such as the display device D4, which has a sufficient remaining battery power, should multicast the screen information of the communication apparatus to the other display devices. Based on the determination result, the session information management unit 104 transmits, to the display device D4, an instruction to perform multicasting. Further, if two or more terminal devices have remaining battery power levels higher than a threshold value, the session information management unit 104 may unicast information to a terminal device of the highest remaining battery power, and cause it to multicast the information to the other terminal devices.

If the remaining battery power levels of all terminal devices are detected to be less than the threshold value, the session information management unit 104 selects to unicast information to all terminal devices.

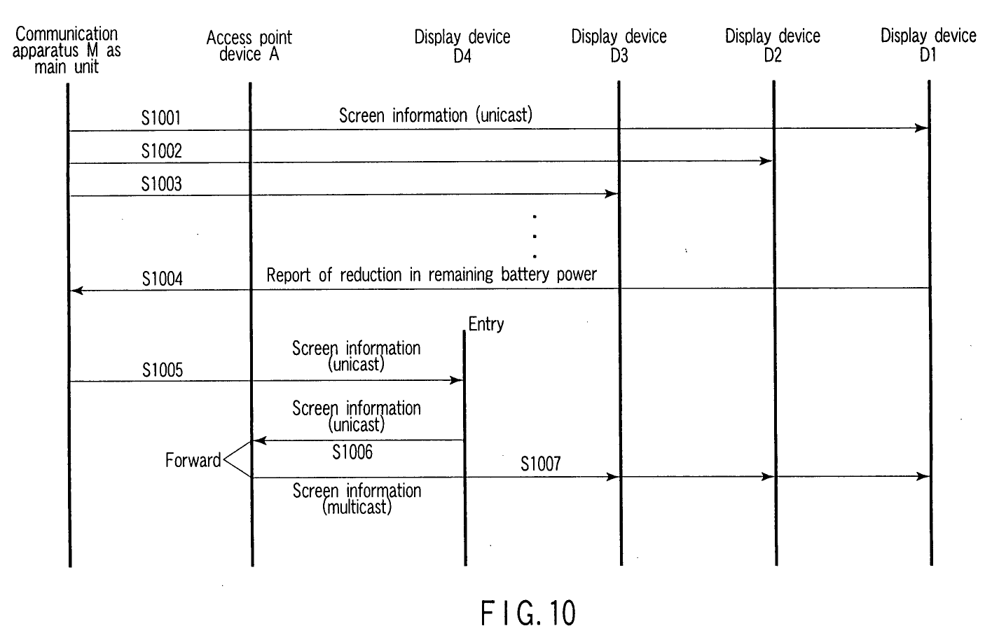

Referring to FIG. 10, a description will be given of the case of reporting a message that the remaining battery power of a terminal device is reduced. FIG. 10 is a sequence view illustrating the flow of data in the MAC layer of the communication system of the embodiment.

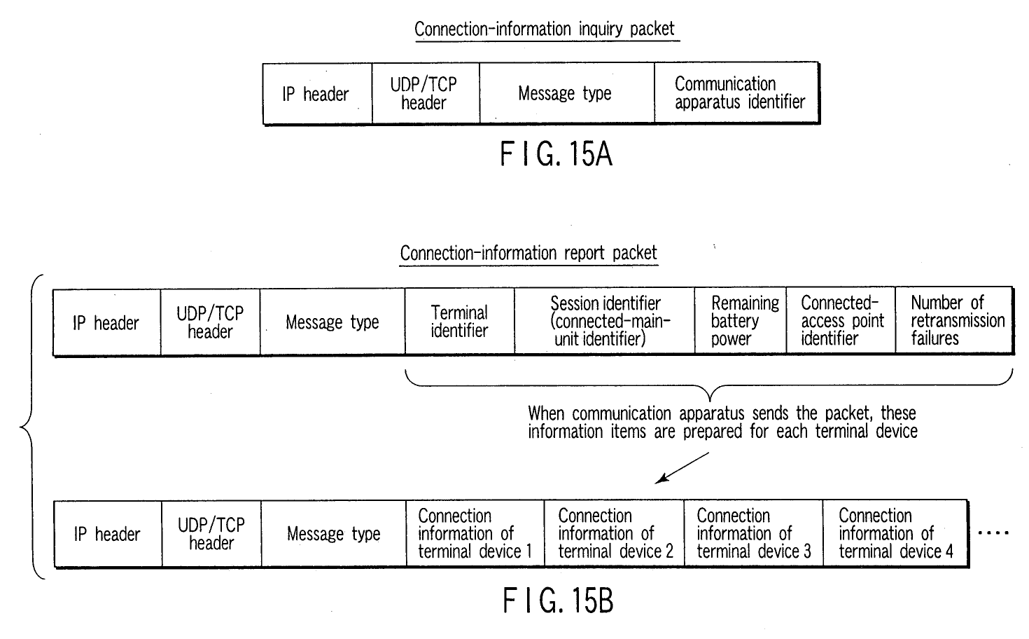

Assume that the communication apparatus M is now unicasting screen information to the display devices D1, D2 and D3, based on UDP/IP (steps S1001, S1002 and S1003). At this time, if the remaining battery power of the display device D1 is reduced, the display device D1 reports to the communication apparatus M that its state has become unstable (step S1004). Concerning the report, a description will be given later with reference to FIGS. 14, 15A and 15B.

In due course, when the display device D4 starts a session to the communication apparatus M to receive screen information, the communication apparatus M designates the display device D4 as a multicast transport terminal, since it determines that the remaining battery power of the display device D1 is low and hence the device D1 is hard to use as a terminal device for performing multicast transport. The communication apparatus M unicasts screen information only to the display device D4 (step S1005). The display device D4, in turn, displays the screen information, and executes multicast transport of the information to the other displays (D1 to D3) via the access point device A (steps S1006 and S1007).

(Wireless Channel Environment of Terminal Device)

A description will now be given of the operation of the communication apparatus for controlling a terminal device with reference to the wireless channel environment of the terminal device.

When the wireless channel environment around a display device is bad, if the communication apparatus causes the display device to transport screen information, the information may not normally be distributed because of packet loss. In the IEEE 802.11 standards, after the communication apparatus unicasts a frame at the MAC layer (MAC unicast transmission), the destination terminal (receiving terminal) of the MAC frame computes Frame Check Sequence (FCS) to confirm that the frame is normally received. After a preset time called Short Inter Frame Space (SIFS) elapses, the terminal returns an ACK frame (acknowledgement) in the MAC layer. In contrast, if the MAC frame is not normally received because of collision or distance attenuation, an ACK frame in the MAC layer is not returned. Therefore, the sender of the MAC unicast frame attempts to retransmit the frame after a randomly set back-off time elapses. Transmission of the frame is repeated a preset upper-limit number of times. If no ACK frame is returned even after the retransmission is made the present number of times, the present MAC frame is discarded, and the next one is transmitted.

Accordingly, when the terminal device, which is intended to multicast the information from the communication apparatus to the other terminal devices, fails in transport even after it repeats the transmission of the MAC unicast frame to the access point device A the preset number of times, the wireless channel environment is determined unstable, and it is desirable not to transport the information from the communication apparatus.

Specifically, based on the report concerning the unstable state sent from the terminal device, the session information management unit 104 of the communication apparatus determines that it is difficult for the terminal device to perform multicast transport, and sets another terminal device belonging to the same BSS as the terminal device for multicasting information to the other terminal devices. Whether the terminal device is in an unstable channel state is determined based on whether the number of times of retransmission at the MAC layer exceeds a preset threshold value, or whether the intensity of the received signal is low.

(Protocol Processing)

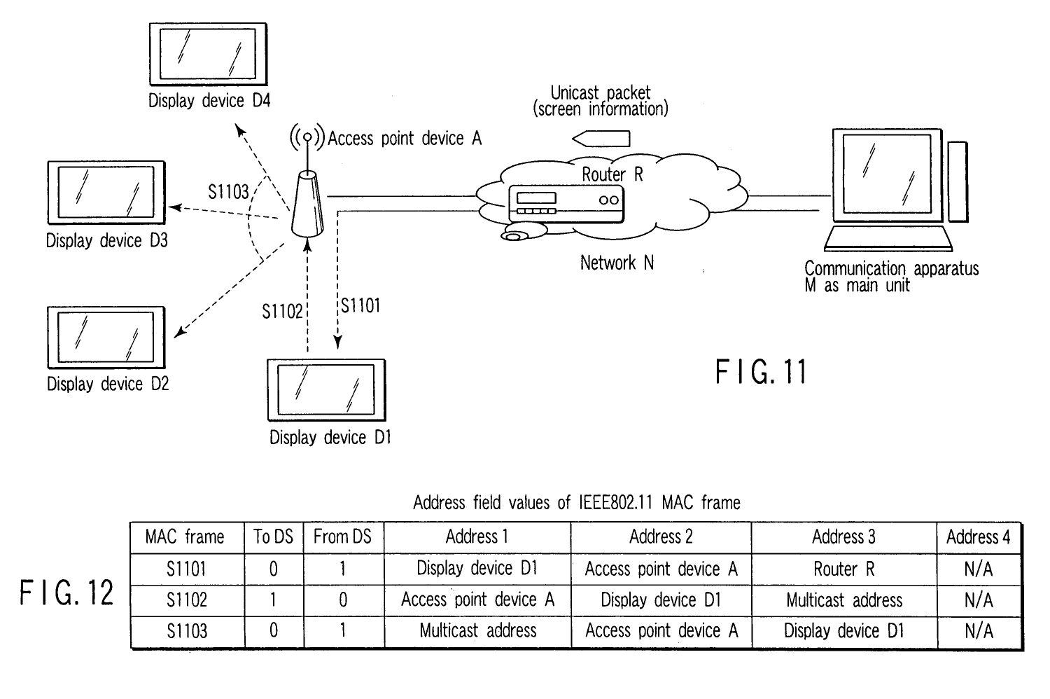

Referring now to FIGS. 11 and 12, a description will be given of processing performed under the IEEE 802.11 protocol.

In the IEEE 802.11 standards, a MAC header has four address fields as shown in FIG. 12, and addresses 1 to 3 are used for communication between the access point device and each terminal device. In FIG. 11, the screen information transmitted by the communication apparatus M is transmitted to the display device D1 via the network N and access point device A (step S1101). This transmission is unicasting at the MAC layer, and hence the display device D1 requires acknowledgment in the MAC layer from the access point device A.

When the display device D1 multicasts information to the other display devices (D2 and D3) (step S1102), the address 3 information of the MAC unicast frame sent from the display device D1 to the access point device A indicates multicast addresses assigned to the other terminal devices. At step S1102, unicasting, which requires an acknowledgement at the MAC layer, is performed. At step S1103, multicasting at the MAC layer, during which no acknowledgement (ACK) is returned from the receiving terminals, is performed.

(Request Information)

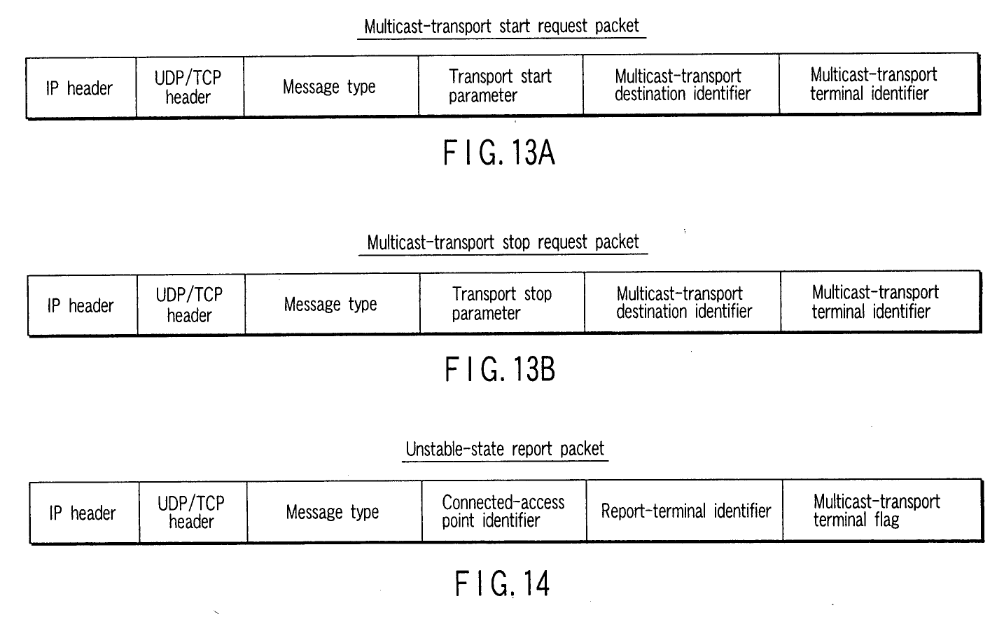

Referring to FIGS. 13A, 13B, 14, 15A and 15B, request information examples transmitted between the communication apparatus and a terminal device will be described.

The multicast-transport start request packet shown in FIG. 13A, and the multicast-transport stop request packet shown in FIG. 13B are transmitted from the communication apparatus to the terminal device. Upon receiving the multicast-transport start request packet, if the multicast transport terminal identifier contained in the packet corresponds to the address of the terminal device, the terminal device not only receives information unicasted from the communication apparatus, but also starts multicasting of the information to the terminal devices with multicast transport destination identifiers (e.g., multicast addresses).

On the other hand, when the terminal device receives the multicast-transport stop request packet from the communication apparatus, it stops multicast transport of information to the other terminal devices and performs only normal reception of information distributed thereto by unicasting.

The unstable-state report packet shown in FIG. 14 is transmitted from the terminal device to the communication apparatus. When, as described above, the remaining battery power of the terminal devices become low, or the wireless channel environment becomes bad, the terminal devices reports to the communication apparatus that its state becomes unstable, using the unstable-state report packet shown in FIG. 14.

The message-type information contained in the unstable-state report packet is information for identifying the packet. In the example of FIG. 14, this information indicates that this packet is an unstable-state report packet. By referring to the message-type information, the packet can be discriminated from the other control packets. The connected-access-point identifier of the packet indicates a MAC address (i.e., the identifier of the BSS) assigned to the access point device which the terminal device is associated with. The report terminal identifier of the packet indicates an address (such as an IP address or MAC address) assigned to the terminal device. The multicast transport terminal flag of the packet is a flag for determining whether the terminal device is a device for performing multicast transport. During multicast transport processing, the flag is on, whereas during processing other than that, the flag is off.

FIGS. 15A and 15B show a connection information inquiry packet and connection information report packet for reporting the connection information of each terminal device, respectively. The connection information inquiry packet shown in FIG. 15A is transmitted from the communication apparatus to a terminal device that corresponds to an identifier (such as an address) contained in the communication apparatus identifier information, when they are connected. The terminal device, in turn, makes a response to the communication apparatus. The connection information inquiry packet may be transmitted by either unicasting or broadcasting.

The terminal identifier contained in the connection information report packet shown in FIG. 15B indicates an address assigned to a terminal device. The session identifier of the packet is information managed between the terminal device and communication apparatus. The remaining power of the packet indicates the remaining battery power of the terminal device. The connected-access-point identifier of the packet indicates an address assigned to the access point device connected to the terminal device. The retransmission failures information indicates the number of retransmission failures that is incremented whenever normal transmission cannot be achieved even after transmission is repeated a preset upper-limit number of times. The message-type information of the packet is used to discriminate various types of packets from each other, like the message-type information contained in the connection information inquiry packet.

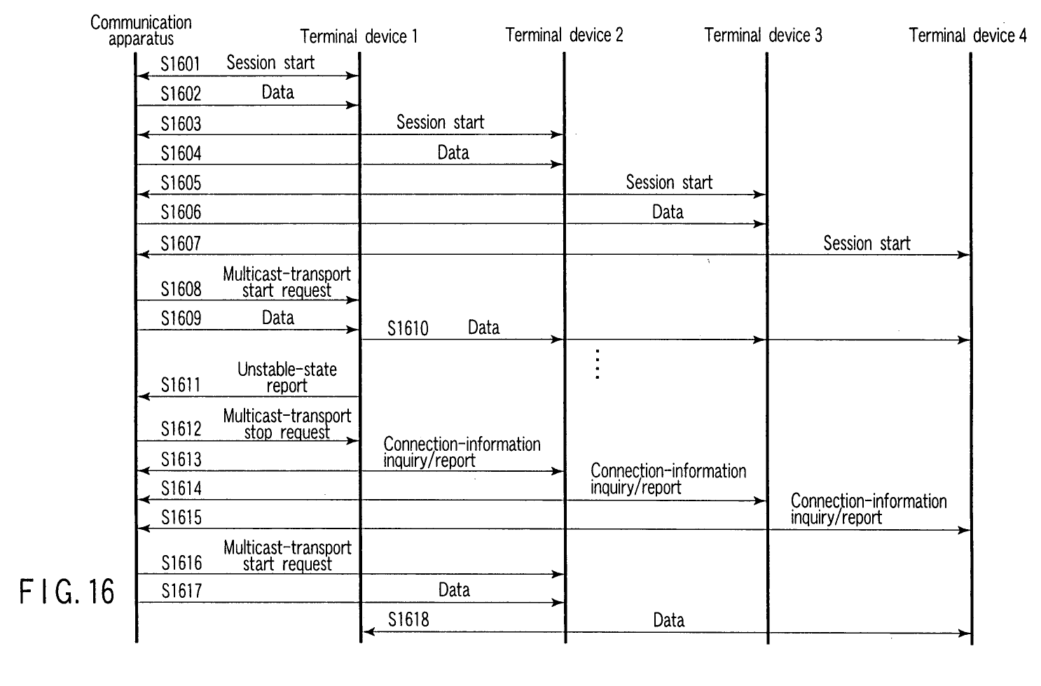

Referring to FIG. 16, a description will be given of a sequence of control using the packets shown in FIGS. 13A to 15B.

The communication apparatus starts sessions with terminal devices 1 to 3 (steps S1601, S1603, S1605), thereby unicasting information thereto. After starting a session with a terminal device 4 (step S1607), the communication apparatus detects that the total number of terminals reaches four, and transmits a multicast transport start request (the packet of FIG. 13A) to the terminal device 1 (step S1608). Subsequently, the communication apparatus unicasts information only to the terminal device 1 (step S1609). The terminal device 1, in turn, multicasts the information to the terminal devices 2 to 4 (step S1610). When it becomes difficult for the terminal device 1 to perform multicast transport, because of, for example, a reduction in remaining battery power, the terminal device 1 transmits an unstable state report (the packet shown in FIG. 14) to the communication apparatus (step S1611). Based on the unstable state report, the communication apparatus transmits a multicast-transport stop request (the packet shown in FIG. 13B) to the terminal device 1 (step S1612), and makes a connection information inquiry to the other terminals 2 to 4 and receives responses therefrom (the packets of FIGS. 15A and 15B) (steps S1613, S1614 and S1615). If the remaining battery power levels of the other terminals are also low, the communication apparatus stops multicast transport processing and perform unicasting on all terminal devices. In the example of FIG. 16, the terminal device 2 is newly designated to perform multicast transport processing. Upon receiving a multicast-transport start request (step S1616), the terminal device 2 multicasts, to the terminal devices 1, 3 and 4, information unicasted from the communication apparatus (step S1617 and S1618). In the embodiment, each terminal device can perform system control in units of BSSs by reporting, to a control terminal (e.g., the communication apparatus), the identifier of an access point device to which each terminal device is connected.

(Operation)

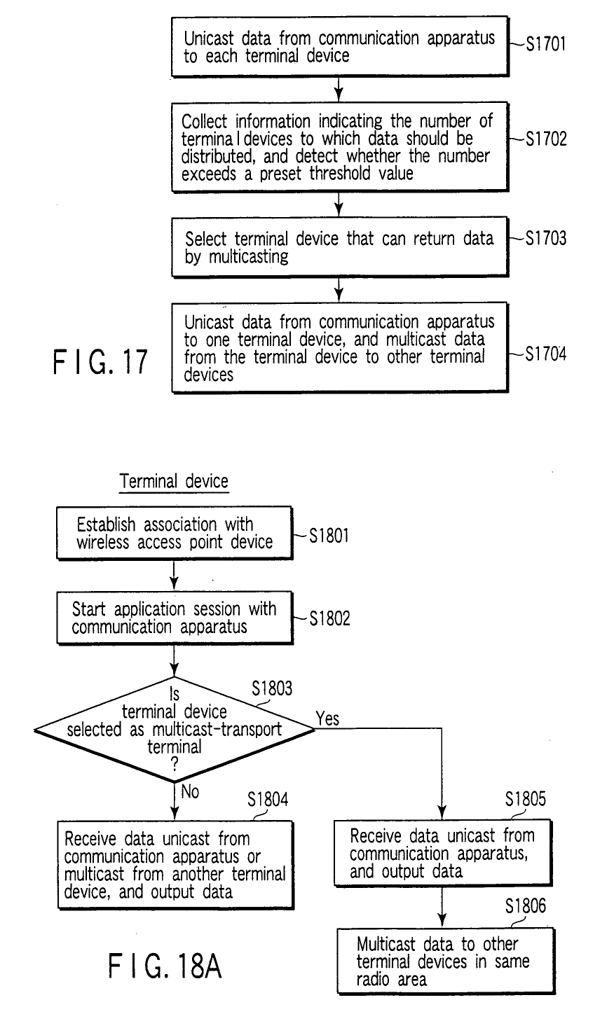

Referring to FIGS. 17, 18A, 18B, 19A and 19B, a description will be given of operation examples of the communication apparatus and terminal devices of the embodiment.

FIG. 17 is a flowchart illustrating an operation example of the communication apparatus of the embodiment. Information is unicasted to each terminal device (step S1701). Information indicating the number of terminal devices to which information should be distributed is collected, and it is determined whether the number exceeds a preset threshold value (step S1702). If it exceeds the threshold value, one of the terminal devices, which multicasts information to the other terminal devices, is selected (step S1703). Information is unicasted to the terminal device selected at step S1703 (step S1704). The selected terminal device multicasts the information to the other terminal devices included in the same BSS.

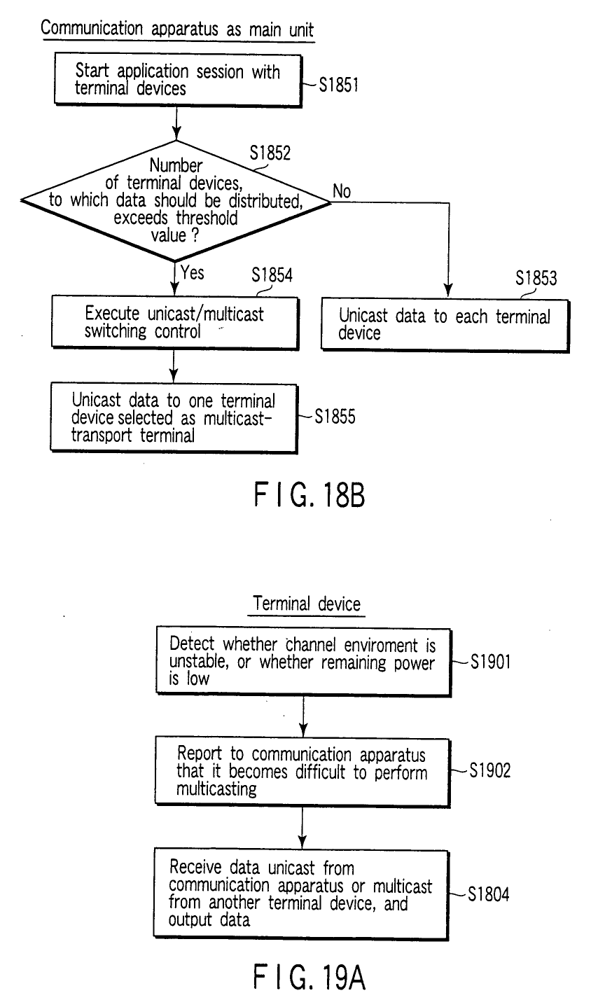

FIG. 18A is a flowchart illustrating a first operation example of the terminal device, and FIG. 18B is a flowchart illustrating a first operation example of the communication apparatus.

<Terminal Device as First Example>

The terminal device establishes an association with a wireless access point device (step S1801), makes an application session with the communication apparatus (step S1802), and determines whether it is selected as a multicast transport terminal by the communication apparatus (step S1803). If the terminal device is not selected as a multicast transport terminal at step S1803, it receives data unicasted from the communication apparatus, or from another terminal device by multicasting (step S1804). In contrast, if the terminal device is selected as a multicast transport terminal at step S1803, it receives data unicasted from the communication apparatus (step S1805), and multicasts the data to the other terminal devices of the same BSS (step S1806).

<Communication Apparatus as First Example>

The communication apparatus starts an application session with each terminal device (step S1851), and determines whether, for example, the number of terminal devices to which data should be distributed exceeds a preset threshold value (step S1852). Although in the example of FIG. 18B, the condition for determining multicasting or unicasting concerns the number of terminal devices, the embodiment is not limited to this as described above. The condition may concern the remaining battery power or wireless channel environment of each terminal device. If the number of terminal devices does not exceed the threshold value, data is unicasted to each terminal device (step S1853). In contrast, if the number of terminal devices exceeds the threshold value, the unicast/multicast switching control unit 106 executes multicast transport via a single terminal device (step S1854). Namely, data is unicasted to the terminal device selected as the multicast transport terminal (step S1855).

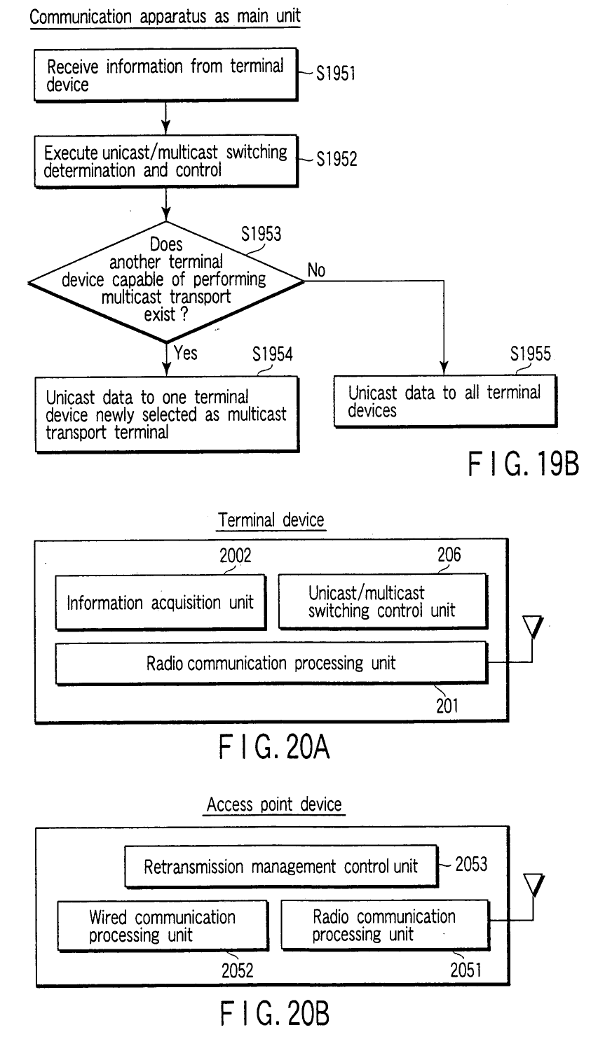

FIG. 19A is a flowchart illustrating a second operation example of the terminal device, and FIG. 19B is a flowchart illustrating a second operation example of the communication apparatus.

<Terminal Device as Second Example>

The terminal device determines whether the wireless channel environment is unstable, or whether the remaining battery power is low (step S1901). If the wireless channel environment is unstable (e.g., if the number of times of retransmission at the MAC layer of the terminal device reaches a preset threshold value), or if the remaining battery power is low (e.g., if the remaining battery power is lower than a preset threshold value), the terminal device reports to the communication apparatus that it becomes difficult for the terminal device to perform multicast transport (step S1902). After that, the same process as step S1804 is performed.

<Communication Apparatus as Second Example>

The communication apparatus receives a report from a terminal device (step S1951), and determines whether switching between unicasting and multicasting should be performed (step S1952). When performing switching between unicasting and multicasting, it is determined whether a terminal device exists, which is other than the terminal device detected at step S1951 and can perform multicast transport (step S1953). If such a terminal device as can perform multicast transport exists, the communication apparatus selects the terminal device as a new multicast transport terminal, and unicasts data to the selected terminal device (step S1954). In contrast, if there is no such terminal device, the communication apparatus unicasts data to all terminal devices (step S1955).

(Modification)

Referring to FIG. 20A, a terminal device according to a modification of the embodiment will be described. Further, referring to FIG. 20B, an access point device will be described.

In the above description, the communication apparatus performs multicast control. Alternatively, a terminal device may perform control for starting/stopping multicast transport, using an information acquisition unit 2002 as shown in FIG. 20A. The information acquisition unit 2002 performs, for example, a connection information inquiry/response, thereby acquiring the connection information of each terminal device concerning, for example, the number of all terminal devices, and performing, based on the connection information, control for determining which terminal device should perform multicast transport. Further, when the communication apparatus reports, to the terminal device as a control terminal, its currently managed terminal-device-group information, the information concerning a plurality of terminal devices may be included in one packet as shown in the lower portion of FIG. 15B.

In the above-described embodiment, when the number of times of retransmission reaches the upper-limit value at the wireless MAC layer of the terminal device (i.e., when the wireless channel environment is bad), this is reported to the communication apparatus (control device). However, if the access point device incorporates a retransmission management control unit 2053 as shown in FIG. 20B, it can report, to the communication apparatus (control device), information indicating a destination terminal device having failed in the transmission of a MAC frame. Note that a radio communication processing unit 2051 is similar to the radio communication processing unit 201, and is used for communication with each communication terminal device. Further, a wired communication processing unit 2052 is used for communication with the communication apparatus.

As described above, in a system in which a network incompatible with multicasting exists in the channel, even if a large number of terminal devices receive the same information from a communication apparatus, efficient transmission of the information in consideration of the network band can be realized by switching the way of transmission from unicasting to multicasting via a terminal device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus for performing data communication with a plurality of terminal devices, comprising:
an acquisition unit configured to acquire, from the terminal devices, a plurality of connection information items corresponding to the terminal devices;
a storage unit configured to store the connection information items;
a selection unit configured to, when transmitting data to the terminal devices, select one of a first scheme and a second scheme referring to the stored connection information items, the first scheme causing the data to be unicasted to the terminal devices, the second scheme causing the data to be unicasted to one terminal device of the terminal devices and then to be multicasted from the one terminal device to the terminal devices other than the one terminal device; and
a transmission unit configured to transmit, to the one terminal device, request information requesting the one terminal device to perform processing of data using the second scheme, and also to transmit the data to the one terminal device, when the selection unit selects the second scheme.

2. The apparatus according to claim 1, wherein:
the acquisition unit is configured to acquire information indicating number of the terminal devices, based on the connection information items; and
the selection unit is configured to select the first scheme when the number is less than a preset value, and selects the second scheme when the number is not less than the preset value.

3. The apparatus according to claim 2, wherein the preset value is four when a transport protocol for unidirectional communication, which requires no acknowledgement from the terminal devices, is employed.

4. The apparatus according to claim 2, wherein the preset value is three when a transport protocol for bidirectional communication, which requires an acknowledgement from the terminal devices, is employed.

5. The apparatus according to claim 1, wherein:
the acquisition unit is configured to acquire, as the connection information items, remaining power levels of the terminal devices; and
the selection unit is configured to select the first scheme when the remaining power levels are all less than a threshold value, and selects the second scheme causing the data to be unicasted to the at least one terminal device when a remaining power level of at least one of the terminal devices is not less than the threshold value.

6. The apparatus according to claim 5, wherein when some of the remaining power levels are not less than the threshold value, the selection unit is configured to select the second scheme and unicast the data to one of the terminal devices, the one terminal device having a highest remaining power level.

7. The apparatus according to claim 1, wherein:
the acquisition unit is configured to acquire, as the connection information items, wireless channel environments of the terminal devices; and
the selection unit is configured to determine that a wireless channel environment of one of the terminal devices is bad, when number of times of retransmission in a radio MAC layer of the one terminal device reaches a threshold value, the selection unit selecting one of terminal devices which are included in the terminal devices and exclude the terminal device with the wireless channel environment determined bad.

8. A terminal device included in a plurality of terminal devices which perform data communication with a communication apparatus, the terminal device comprising:
an acquisition unit configured to acquire instruction information and data from the communication apparatus, the instruction information indicating one of a first scheme and a second scheme, the first scheme causing data to be unicasted to the terminal devices, the second scheme causing data to be unicasted to one terminal device of the terminal devices and then to be multicasted from the one terminal device to the terminal devices other than the one terminal device;
a selection unit configured to select, referring to the instruction information, whether the data is to be multicasted to the terminal devices other than the one terminal device; and
a transmission unit configured to transmit by multicasting the data to the terminal devices other than the one terminal device, when the selection unit selects that the data is to be multicasted to the terminal devices other than the one terminal device.

9. The device according to claim 8, further comprising:
another acquisition unit configured to acquire connection information of the terminal devices; and
another selection unit configured to select, referring to the connection information, whether the data is to be multicasted to the terminal devices other than the one terminal device.

10. The device according to claim 8, further comprising:
a detection unit configured to detect a remaining power of the terminal device; and
another transmission unit configured to transmit, to the communication apparatus, a message that it is difficult to multicast the data to the terminal devices other than the terminal device, when the remaining power is lower than a threshold value.

11. The device according to claim 8, further comprising:
a count unit configured to count number of times of retransmission of a unicast frame in a radio MAC layer of the terminal device; and
another transmission unit configured to transmit, to the communication apparatus, a message that it is difficult to multicast the data to the terminal devices other than the terminal device, when the number reaches a threshold value.

12. The device according to claim 8, further comprising:
a detection unit configured to detect a received-signal intensity of the terminal device; and
another transmission unit configured to transmit, to the communication apparatus, a message that it is difficult to multicast the data to the terminal devices other than the terminal device, when the received-signal intensity is lower than a threshold value.

13. A communication method for performing data communication with a plurality of terminal devices, comprising:
acquiring, from the terminal devices, a plurality of connection information items corresponding to the terminal devices;
preparing a storage unit configured to store the connection information items;
selecting, when transmitting data to the terminal devices one of a first scheme and a second scheme referring to the stored connection information items, the first scheme causing the data to be unicasted to the terminal devices, the second scheme causing the data to be unicasted to one terminal device of the terminal devices and then to be multicasted from the one terminal device to the terminal devices other than the one terminal device; and
transmitting, to the one terminal device, request information requesting the one terminal device to perform processing of data using the second scheme, and also transmitting the data to the one terminal device, when the second scheme is selected.

14. A communication program recorded in a computer readable recording medium and permitting a communication apparatus provided with a computer to perform data communication with a plurality of terminal devices, comprising.:
means for instructing a computer to acquire, from the terminal devices, a plurality of connection information items corresponding to the terminal devices;
means for instructing the computer to access to a storage unit configured to store the connection information items;
means for instructing the computer to, when transmitting data to the terminal devices, select one of a first scheme and a second scheme referring to the stored connection information items, the first scheme causing the data to be unicasted to the terminal devices, the second scheme causing the data to be unicasted to one terminal device of the terminal devices and then to be multicasted from the one terminal device to the terminal devices other than the one terminal device; and
means for instructing the computer to transmit, to the one terminal device, request information requesting the one terminal device to perform processing of data using the second scheme, and also transmitting the data to the one terminal device, when the second scheme is selected.
